(19) United States
(12) Patent Application Publication
(10) Pub. No.: US 2016/0321613 A1
(43) Pub. Date: Nov. 3, 2016

(54) MODEL GENERATOR FOR CAREER PATH OPTIONS

(71) Applicant: Linkedln Corporation, Mountain View, CA (US)

(72) Inventors: Yi Wang, Sunnyvale, CA (US); Dacheng Zhao, Sacramento, CA (US); Guan Wang, San Jose, CA (US); Song Lin, Santa Clara, CA (US); Lutz Thomas Finger, Mountain View, CA (US)

(21) Appl. No.: 15/018,714

(22) Filed: Feb. 8, 2016

Related U.S. Application Data
(60) Provisional application No. 62/155,413, filed on Apr. 30, 2015.

(51) Int. Cl. G06Q 10/10; G06Q 50/00

(52) U.S. Cl. CPC G06Q 10/1053; G06Q 50/01

(57) ABSTRACT

Methods of identifying and communicating information pertaining to career path gaps between members of a social network system are disclosed. A career path corresponding to a plurality of members of a social network system is identified. Levels of professional qualifications of each of the plurality of members are identified. The identifying includes analyzing known data items pertaining to the levels of the professional qualifications and analyzing additional data items inferred from the known data items pertaining to the levels of professional qualifications for each of the plurality of members. A career path gap between a member of the plurality of members and an additional member of the plurality of members is identified. The career path gap includes a difference in the levels of professional qualifications between the member and the additional member. Information pertaining to the career path gap is communicated for presentation to the member in a user interface.

### CROSS-REFERENCE TO RELATED APPLICATIONS

This application claims the benefit of U.S. Provisional Application No. 62/155,413, filed Apr. 30, 2015, which is hereby incorporated by reference in its entirety.

### TECHNICAL FIELD

The present disclosure generally relates to the technical field of social-networking systems and, in one embodiment, to analyzing a vast array of information maintained by a social network with respect to careers of members of the social network so as to be able to provide one or more of the members with personalized sets of career path options.

### BACKGROUND

A social network system, such as LinkedIn, may allow members to declare information about themselves, such as their professional qualifications or skills. In addition to information the members declare about themselves, a social network system may gather and track information pertaining to behaviors of members with respect to the social network system and social networks of members of the social network system. Analyzing a vast array of such information may help to come up with solutions to various problems that may not otherwise have clear solutions.

### DESCRIPTION OF THE DRAWINGS

Some embodiments are illustrated by way of example and not limitation in the accompanying drawings, in which:

FIG. 1 is a block diagram of the functional modules or components that comprise a computer-network based social network service, including application server modules consistent with some embodiments of the invention;

FIG. 2 is a block diagram depicting some example application server modules of FIG. 1;

FIG. 3 is a flow diagram illustrating an example method of generating and communicating information pertaining to one or more career path options for presentation to a member of a social networking system in a user interface;

FIG. 4 is a flow diagram illustrating an example method of facilitating the establishment of mentorship relationship between members of a social network system;

FIG. 5 is a flow diagram illustrating an example method of using inferred attributes of a member in determining probabilities of career paths for a member of a social network system;

FIG. 6 is an example user interface that may be presented in a client application executing on a device of a user to provide the user with insights into career path options for a selected career goal;

FIG. 7 is an example user interface that may be presented in a client application executing on a device of a user to provide the user with insights into professional qualifications and time periods for advancing along a particular career path option;

FIG. 8 is an example user interface that may be presented in a client application executing on a device of a user to provide the user with options to participate in mentorship relationships with other members of the social networking system; and

FIG. 9 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for providing a member of a social network system with information pertaining to career path options that may be available to the member. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

A member of a social networking system may declare one or more professional qualifications, but not be aware of whether those professional qualifications may lead to bigger and better career opportunities for the member in future. For example, the member may know approximately where the member currently stands in a particular technical field or industry, but be unaware of how other members, who were situated similarly to the member in years past, advanced in their careers.

A social networking system may have a vast array of information pertaining to other members, including data items pertaining to education, work experience, skills, or other qualifications of each other member at particular points during their careers. An analysis of the information may expose one or more career path options for a particular member that the member may not be aware of. For example, an analysis of the information may show one or more traditional career paths or one or more non-traditional career paths that other members situated similarly to the member in years past, elected to take. Additionally, an analysis of the information may show the most efficient routes that a member may take to transition from one career to another career, from one position to another position, and so on.

In various embodiments, a system may analyze vast amounts of data representing careers of members of the social networking system to identify a “future you”—that is, another member of the social network system who represents the best of what a member may become in the future. In various embodiments, the social network system may identify such inspirational members as possible mentors for the member. Thus, for example, a senior member of an organization may be identified for a junior member of the organization as a potential mentor based on a trajectory of the work history, skills, education, of the junior member in comparison to those of the senior member. The junior member may then be notified of the senior member or vice versa. Upon mutual agreement, the junior member may be introduced to the senior member via the social network. Similarly, individuals seeking new careers or non-traditional career paths may be introduced to members who have taken particular routes—independently of whether the members are affiliated with a same organization.

In various embodiments, a back-end algorithm may be configured to identify the true abilities of a member based on information that the member specifies about herself or himself (e.g., profile data), information that the system collects pertaining to the member (e.g., behavior data, such as articles read, pages browsed, messages posted, connections made, or other actions), information about declared or acknowledged connections of a member (e.g., social graph data), and so on. After the true abilities of the member have been identified, several career path options for the member may be identified (e.g., based on an analysis of the true abilities of other members of the social network system that were situated similarly to the member in years past). Various career path options may be presented to the member in a user interface. Additionally, information pertaining to work experience, skills, education, or other requirements of each career path may be presented to the member. Moreover, one or more particular individuals who represent the best of who a member may become with respect to each career path (e.g., a member's “future you”) may be identified. Various options for allowing the member to engage with the member's “future you” may then be presented to the member.

In various embodiments, a method of identifying and communicating career path options for presentation to a member of a social networking system are disclosed. A selection of a job title from a member of a social networking system is received. Additional members of the social networking system having the job title are identified. A career path for the member is identified based on an analysis of a profile corresponding to the member in comparison to profiles corresponding to the additional members. Information pertaining to the career path may be communicated for presentation to the member in a user interface.

In various embodiments, methods of identifying and communicating information pertaining to career path gaps between members of a social network system are disclosed. A career path corresponding to a plurality of members of a social network system is identified. Levels of professional qualifications of each of the plurality of members are identified. The identifying includes analyzing known data items pertaining to the levels of the professional qualifications and analyzing additional data items inferred from the known data items pertaining to the levels of professional qualifications for each of the plurality of members. A career path gap between a member of the plurality of members and an additional member of the plurality of members is identified. The career path gap includes a difference in the levels of professional qualifications between the member and the additional member. Information pertaining to the career path gap is communicated for presentation to the member in a user interface.

In various embodiments, a career path may include multiple sub-career paths, such as progression from one career path (e.g., an engineering career path) to another career path (e.g., an attorney career path) or vice versa. Thus, for example, particular sub-career path may be identified as leading to additional sub-career paths. Together, the sub-career paths may form a career path, even though the sub-career paths are associated with careers that are traditionally considered to be separate.

Other advantages and aspects of the present inventive subject matter will be readily apparent from the description of the figures that follows.

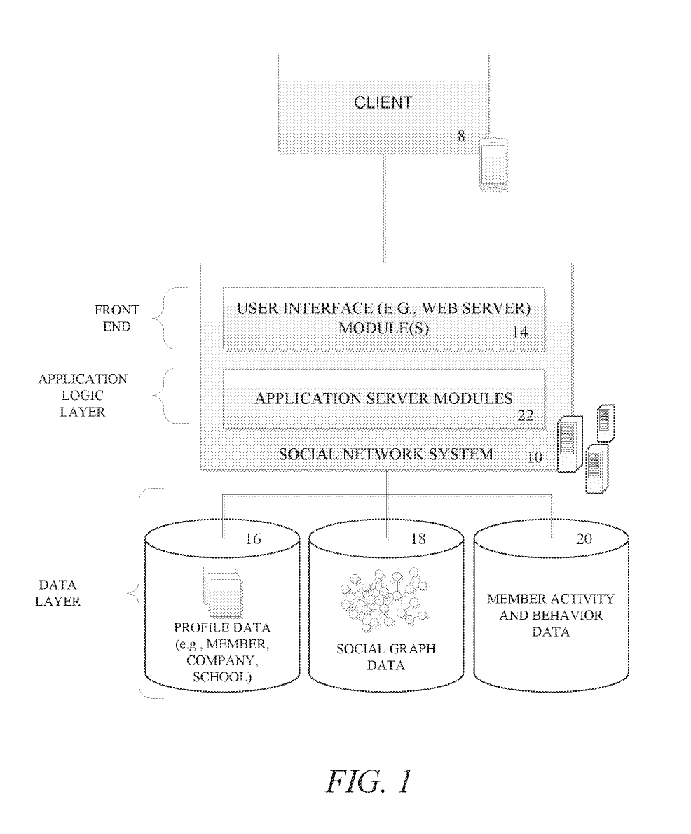

FIG. 1 is a block diagram of the functional modules or components that comprise a computer- or network-based social network service 10 consistent with some embodiments of the invention. As shown in FIG. 1, the social network system 10 is generally based on a three-tiered architecture, comprising a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the social network service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the social network service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generates various user interfaces (e.g., web pages) with data retrieved from various data sources in the data layer. With some embodiments, individual application server modules 22 are used to implement the functionality associated with various applications, services and features of the social network service. For instance, a messaging application, such as an email application, an instant messaging application, or some hybrid or variation of the two, may be implemented with one or more application server modules 22. Of course, other applications or services may be separately embodied in their own application server modules 22,

The social network service may provide a broad range of applications and services that allow members the opportunity to share and receive information, often customized to the interests of the member. For example, with some embodiments, the social network service may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in a database (not shown). When a member joins a group, his or her membership in the group will be reflected in the social graph data stored in the database with reference number 18. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 18.

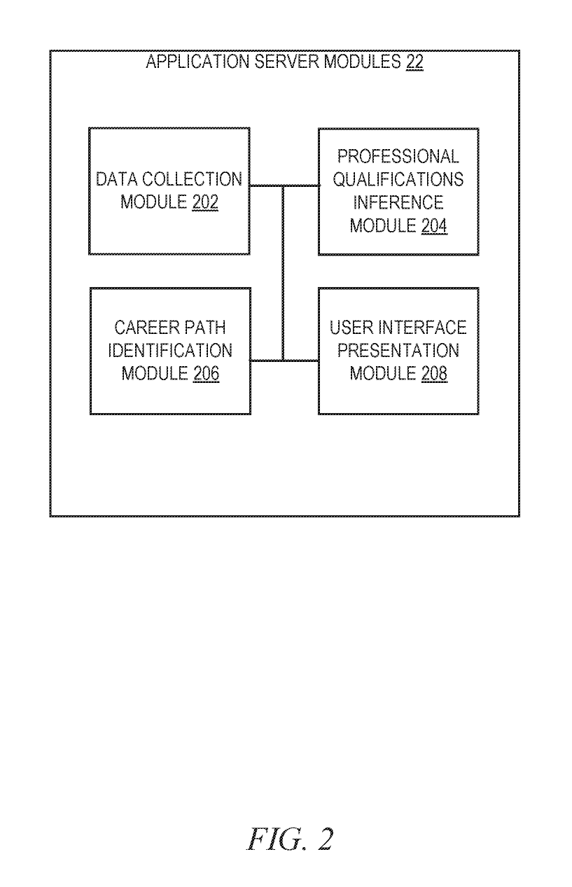

FIG. 2 is a block diagram depicting some example application server modules 22 of FIG. 1. A data collection module 202 may be configured to collect career path data corresponding to members of a social network system. Such data may include profile data, behavior data, and social network data, as described in more detail below. A professional qualification inference module 204 may be configured to make inferences about professional qualifications of members of the social network system. The inferences may be based on an application of a Hidden Markov Model (HMM) or various algorithms described in more detail below. A career path identification module 206 may be configured to identify one or more career paths for members of the social network system. The career paths may be identified based on a comparison between a data corresponding to a member and data corresponding to other members who were similarly situated to the member at a previous time, as discussed in more detail below. Furthermore, career path identification module 206 may calculate probabilities that a member will follow each of the identified career paths based on career path scores, the HMM, a comparison algorithm, and other data or algorithms, as described in more detail below. A user interface presentation module 208 may be configured to generate a user interface for presentation to the user. The user interface may include information pertaining to identified career paths and probabilities corresponding to the career paths. Furthermore, the user interface may illustrate career gaps between a member and other members with respect to various career paths, as described in more detail below.

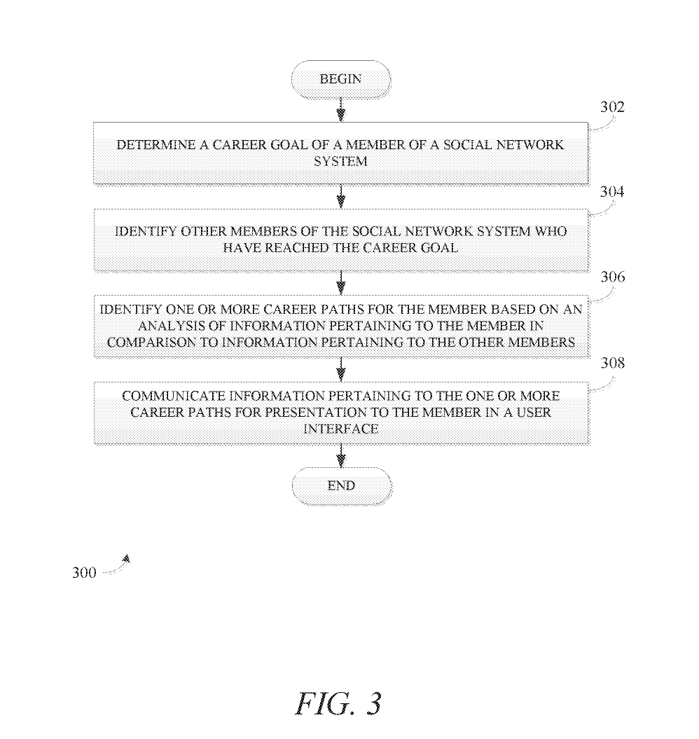

FIG. 3 is a flow diagram illustrating an example method 300 of generating and communicating information pertaining to one or more career path options for presentation to a member of a social networking system in a user interface. In various embodiments, the method 300 may be implemented by one or more of the modules of FIG. 2. At operation 302, the data collection module 202 determines a career goal of a member of a social network system. In various embodiments, the career goal may be based on input from the member. For example, the member may select a job title from a list of job titles of other members of the social networking system who have previously held the current job title of the member or one or more past job titles of the member. As another example, the career goal may be based on a projected career path of the member and information pertaining to job titles the member will hold in the projected career path. The projected career path may be a career path that is determined to be the most likely career path that the member will follow based on an analysis of the profile of the member in comparison to profiles of other members of the social networking system. For example, for a member who has previously held titles of “Technical Writer Intern” and “Technical Writer,” the data collection module 202 may determine, based on, for example, information pertaining other members who have held similar titles for similar amounts of time, that the most likely career path for the member includes titles of “Senior Technical Writer,” “Principal Technical Writer,” or “Documentation Manager.” In some examples, members with the same job title during a certain period in the past may be identified and the career titles held by those members a particular number of years later may be used to find the breakdowns of the most likely career paths. In some examples, an HMM, discussed in more detail below, may be used to identify likely transitions of the user from one job title to the next over a number of years. Furthermore, the data collection module 202 may select one of these titles as a projected career goal for the member based on, for example, a time period of the projection relative to the average length of time each job title was held by other members on a similar career path. For example, for a two-year career goal projection, the data collection module 302 may identify “Senior Technical Writer” as the career goal. For a five-year career goal projection, the data collection module 202 may identify “Documentation Manager” as the career goal. In various embodiments, a career path may include a progression of a person through various levels of jobs, such as from entry-level jobs to senior management jobs to executive jobs. The career path may include a series of job titles a person typically holds before reaching a goal job title. The career path may include various milestones, including education, work experience, skills, and achievement milestones. The career path may include a progression of a person through various job-rating metrics, such as work environment (e.g., hazards, amount of public contact, confinement, or other work conditions), income or salary (e.g., growth potential based on starting salaries, mid-level salaries, and senior-level salaries), job outlook (e.g., employment growth or growth potential, unemployment rates), stress factors (e.g., amount of travel, deadlines, physical demands, hazards, competitiveness, and so on), job satisfaction, and so on.

In various embodiments, non-traditional career goals may also be considered. For example, a less likely career goal for a member who has a current title of “Software Engineer” may be a “Patent Attorney.” For example, a small percentage of other members of the social network system who previously held the title “Software Engineer” may have gone on to hold the title “Patent Attorney.” The identification of the non-traditional career goals may be based on job titles that a lower percentage of other members went on to hold after holding the member's current job title. Additionally, the identification of the non-traditional career goals may be based on an inverse percentage corresponding to transitions between job titles for the member based on the HMM discussed below. In various embodiments, a member may be presented not only with the career paths that the member is most likely to be following, but also career paths that the member is unlikely to follow, based on career paths actually followed by other members of the social network system. The possible career paths and their percentages may be presented to the member as candidate career goals that the member may select. Thus, in various embodiments, the data collection module 202 may determine that the ultimate career goal of a member is actually a non-traditional career goal relative to other members of the social networking system who appear to be on career path that is similar to the member.

In various embodiments, the data collection module 202 may identify which of the possible career paths a member is likely to be considering based on various data collected about the user in addition to the profile data (e.g., work history and education) provided by the user. For example, the data collection module 202 may monitor behavior of the user with respect to the social network system, such as articles that the member has read recently, content items that the user has posted, responses (e.g., replies or likes) that the user has made in response to postings of other users, messages that the user has sent, and so on, to identify which of the identified set of career paths a member may be considering. Additionally, the data collection module may consider the social network of the member, such as the members that the member has declared or acknowledged as a connection, members that the user is following, and so on, to determine whether the social network of the member is indicative of which of the possible career paths the member may be considering. Thus, based on weightings assigned to the various data collected from the profile of the member, the behavior of the member, and the social network of the member, the data collection module 202 may identify which career path the member is most likely considering, such as a traditional career path or a non-traditional career path (e.g., a career path that few of the other members that were previously situated similarly to the member followed). In various embodiments, after the possible career paths for a member are identified (e.g., based on match of profile data or HMM modeling, as discussed in more detail below), a career path selection score may be generated for each possible path for the member. The career path selection score may represent a likelihood that the member will select the associated career path. The career path selection score may be generated based on behavior of the member with respect to the social network system. For example, a career path selection score for a particular one of the career path options for the member may be increased based on various factors, such as a determination that more of the connections of the member followed the career path, the member is following other members who followed the career path, the member has recently viewed content items pertaining to the career path, the member has recently begun following other members who followed the career path, the member has been applying for jobs corresponding to the career path, and so on.

At operation 304, the data collection module 304 may identify other members of the social network system who have reached the determined career goal of the member. In various embodiments, the other members may be ranked based on how similarly situated they were to the current position of the member before attaining the career goal of the member. For example, the historical profiles of the other members, including the titles of the other members, the lengths of times the titles were held by the other members, the education of the other members (e.g., degrees attained, universities attended) and so on, may be compared to the current profile of the member who has the identified career goal. Additionally, the historical behaviors and social networks of the other members may be compared to the current behaviors and social networks of the member. For example, if other members of the social network accessed particular types of content items, followed particular types of other members, applied for particular types of other jobs, and so on, before selecting a particular career path option, those behaviors may be used to adjust a career path selection score for the member corresponding to each of the possible career paths for the member. Thus, a set of candidate members who previously matched the current career situation of the member (e.g., based on any one or combination of profile data, social network data, and behavior data) may be identified and ranked.

At operation 306, the career path identification module 206 may identify one or more career path options for the member. The career paths identified may be based on an analysis of information pertaining to the member in comparison to information pertaining to the identified set of members who were situated similarly to the member in their careers and went on to achieve the identified career goal of the member. The various paths may be identified based on additional education, skills, or work experience that was attained by each of the set of members who achieved the career goal of the member. For example, it may be determined that a first career path taken by a first group of the set of members included attaining one or more new educational degrees, certifications, classes, and so on, whereas a second career path taken by a second group of the set of members included earning a particular amount of work experience at each of one or more different jobs (e.g., job titles). Other career path options may include mastering particular skills or attaining particular achievements. In various embodiments, the set of members who achieved the career goal of the member may be grouped based on similar combinations of education, skills, work experience, achievements, and so on, that led to their achieving the identified career goal of the member. In various embodiments, the difference between a current position of a member with respect to a particular career path (e.g., in terms of any relevant factor, such as levels of education, skills, work experience, achievements, and so on) and a current position of another member with respect to the career path may be referred to as a career gap.

At operation 308, the user interface presentation module 208 may generate a user interface for presentation to the member. The user interface may identify the career path options available to the member. The career path options may be based on the identified career goal of the member and information pertaining to a set of other members of the social network system who, in the past, were situated similarly to the member in their careers and went on to achieve the identified career goal of the member. In various embodiments, the career path options may include combinations of professional achievements (e.g., education, skills, work experience, and so on) of the other members that led to their accomplishment of the career goals. For example, it may be determined that one career path option for the member is to obtain a particular degree and learn a certain set of skills and another career path option for the member is to work for a particular number of years in a particular position within a company and achieve the same or a different set of skills. In various embodiments, the career path options may be presented to the member in a timeline such that the member may determine that approximate amount of time involved in pursuing each element of each career path. In various embodiments, various other aspects of each career path may be highlighted for consideration by the member, such as the costs or difficulty involved in satisfying each milestone of the career path. Thus, the member may be presented with information pertaining a variety of career path options, including traditional or non-traditional career path options, such that the member can choose a career path option that best meets the member's personal needs.

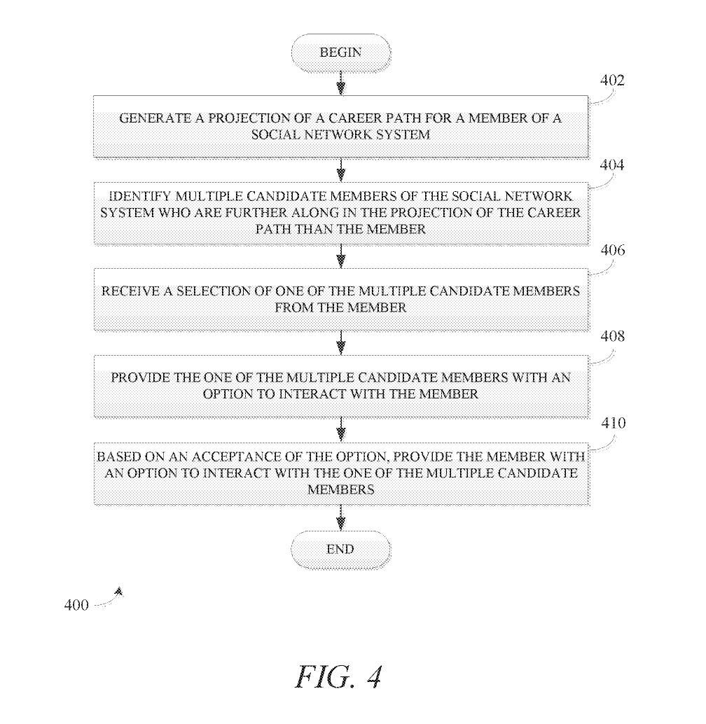

FIG. 4 is a flow diagram illustrating an example method 400 of facilitating the establishment of mentorship relationship between members of a social network system. In various embodiments, the method 400 may be implemented by one or more of the modules of FIG. 2. At operation 402, the data collection module 202 may generate a projection of a career path for a member of the social network system. In various embodiments, the projection may be based on any of the factors discussed above with respect to FIG. 3.

At operation 404, the career path identification module 206, may identify multiple candidate members of the social network system who are further along in the projected career path of the member than the member is. For example, the career path identification module 206 may identify one or more candidates who have achieved one or more of the milestones indicated in the career path, such as educational milestones, skill milestones, work experience milestones, leadership milestones, or other achievements, such as receiving awards, publishing in a journal, being featured in the news, and so on.

At operation 406, the career path identification module 206 may receive a selection of one of the candidate members from the member, the selection indicating that the member wishes to receive mentorship from the selecting member with respect to the identified career path.

At operation 408, the career path identification module 206 may notify the selected member of the request for mentorship and provide an option for the selected member to establish a mentorship relationship with the requesting member.

At operation 410, based on an acceptance of the option by the mentoring member, the user interface presentation module 208 may provide the member with various options to interact with the member seeking the mentoring. In various embodiments, the options may include facilitating private coaching by the mentor (e.g., via a private communication channel) or providing access to the mentee to a special forum, such as a question and answer forum, that is moderated by the mentor for one or more mentees. In various embodiments, the options may include sharing additional information about the mentor with the mentees, such as information pertaining to articles that the mentor is currently reading, projects that the mentor is currently working on, and so on. In various embodiments, the options may include giving mentees access to at least some of the profile data of the mentor that is not publicly available to other members of the social network system, such as insightful information pertaining to the education, skills, work experience, or other professional qualifications of the mentor.

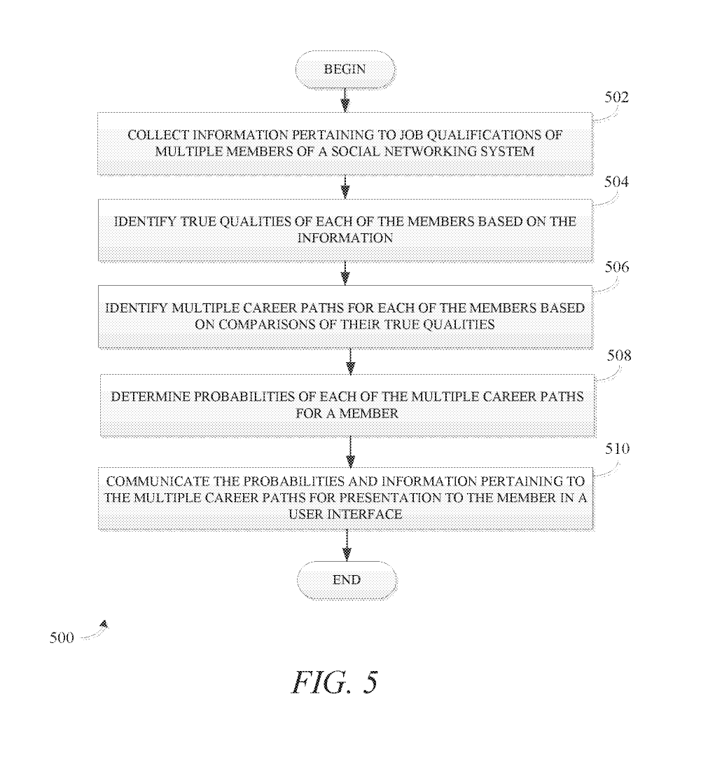

FIG. 5 is a flow diagram illustrating an example method 500 of using inferred attributes of a member in determining probabilities of career paths for a member of a social network system. In various embodiments, a HMM is used to model transitions of a member of the social network between possible states, such as a progression in attaining professional qualifications that are relevant to advancing along a career path. The probability of a state change is based on possible observations of a member and probabilities that the observations indicate a particular state of the member. The observations included in the HMM are any observations that the data collection module 202 is able to make about a member, such as information that the member specifies in the member's profile, behavior of the member, and the social network of the member, as described above. The various states of each member are then mapped to the observations with a probability or confidence.

Based on the possible observations and the probabilities that the observations correspond to a particular state, inferences are made about the professional qualifications of each member. For example, based on an observation that a member is part of an alumni network at a particular university, it may be inferred from the HMM that there is a certain percentage chance that member has attained a degree from that university. Furthermore, based on an analysis of a social network of the member including graduates from the university having a Computer Science degree, it may be inferred from the HMM that there is a certain percentage chance that the member has also attained a Computer Science degree. Based on these observations, it may be inferred with a certain degree of likelihood that the member is about to transition from being a student at the university to being employed at a corporation as a Software Engineer. The HMM may be applied to each possible professional qualification relevant to career paths to all or subsets of members of the social network system. Thus, a far more complete profile of each member may be developed based on the partial information collected for each member. From the more complete profile data the career path options may be identified and probabilities of each career path option assigned.

In various embodiments, a comparison algorithm may be used to compare a member to other members based on one or any combination of profile data (e.g., education, skills, work experience, achievements, demographics, and so on), behavior data (actions that the members have performed with respect to the social network system, as described above), and social network data (e.g., types of connections that the members have formed with other members of the social network system). In various embodiments, the comparison may be made at an offset. For example, the current position of a member may be compared to a position of another member at a particular point in the past (e.g., two, four, six, or eight years ago). In various embodiments, a matching score may represent a strength of a match between a member and another member with respect to a particular career path. An initial matching score may be based on a particular profile data element, such as a job title. The matching score may then be refined based on other profile data elements, such as skills, education, and work experience. The matches of a member may be prioritized or ranked based on a blending of various factors, including the match score, a frequency of the match score (e.g., how often similar matches are made), and a match desirability (e.g., a popularity of a match among other members of the social network system, such as how often profiles of the other members are accessed).

In various embodiments, the comparison algorithm may be used in conjunction with the HMM to, for example, identify career path options for a member and a likelihood that a member will pursue one of the career path options.

At operation 502, the data collection module 202 collects data pertaining to the members of the social networking system, as described above. The data collected serves as observations for the HMM.

At operation 504, the professional qualifications inference module 404 infers the states of each of the members with respect to their professional qualifications. For example, the professional qualifications inference module 404 identifies the states of the education, skills, and achievements of each member based on probabilities that the observations correspond to those states.

At operation 506, the career path identification module 206 identifies multiple career paths for each of the members based on comparisons of their true qualities. The true qualities correspond to the hidden states of the HMM.

At operation 508, the career path identification module 206 uses the HMM to identify probabilities of transitioning of members between states, such as the transitioning of a member from a first job title to a second job title in a career path.

At operation 510, the probabilities and information pertaining to the multiple career path options are communicated for presentation to the member in a user interface. For example, the probabilities derived from the HMM that the user will transition from one job title to another job title may be presented to the user. The user may then select from the available career path options to learn more information about the career path options, as described above.

In various embodiments, further analysis of the user with respect to the accuracy of the career path projection may be used to refine the HMM. Thus, the probability that a particular observation corresponds to a particular state of a professional qualification of the member and the probability that a state transition is occurring may be adjusted based on input from the user or behavior of the user with respect to the information presented in the user interface.

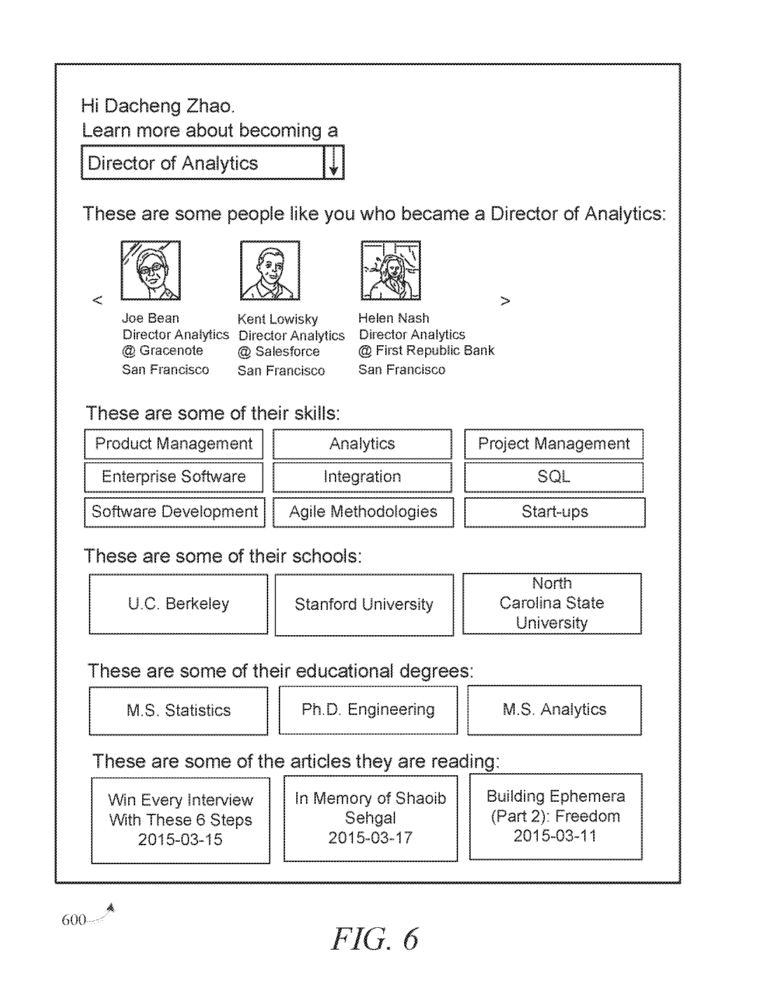

FIG. 6 is an example user interface 600 that may be presented in a client application executing on a device of a user to provide the user with insights into career path options for a selected career goal. In various embodiments, the user interface includes a user interface element, such as a drop-down dialog box, for selecting a career goal (e.g., as described in more detail with respect to FIG. 3), such as a job title of “Director of Analytics.”

The user interface includes a listing of a subset of members who were previously situated similarly to the member and went on to achieve the career goal of the member. The user interface also lists professional qualifications of the members who achieved the career goal, such as their skills, educational degrees, and so on. The user interface also includes information pertaining to the members, such as articles they are reading, news they have been mentioned in, and so on.

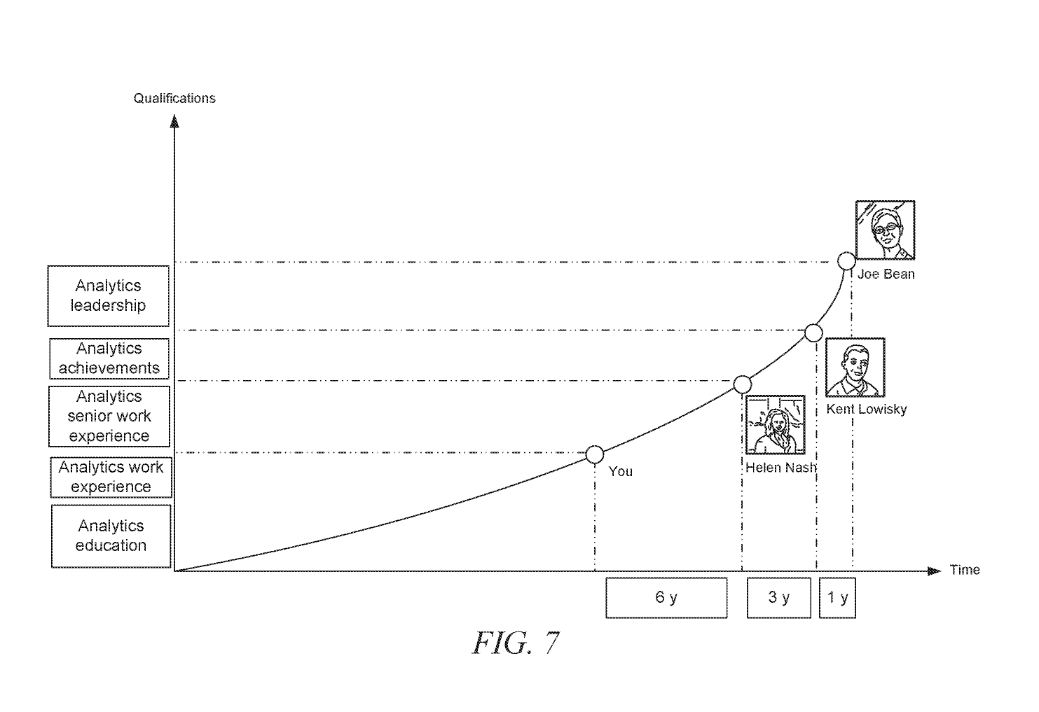

FIG. 7 is an example user interface 700 that may be presented in a client application executing on a device of a user to provide the user with insights into professional qualifications and time periods for advancing along a particular career path option.

In various embodiments, the professional qualifications of selected members of the social network system who have achieved a career goal of the member are depicted with respect to the time period over which the qualifications were achieved by selected members. Although only a single career path is depicted, it is contemplated that multiple career paths may be depicted on the graph, each having different sets of qualifications, as discussed above with respect to FIG. 4.

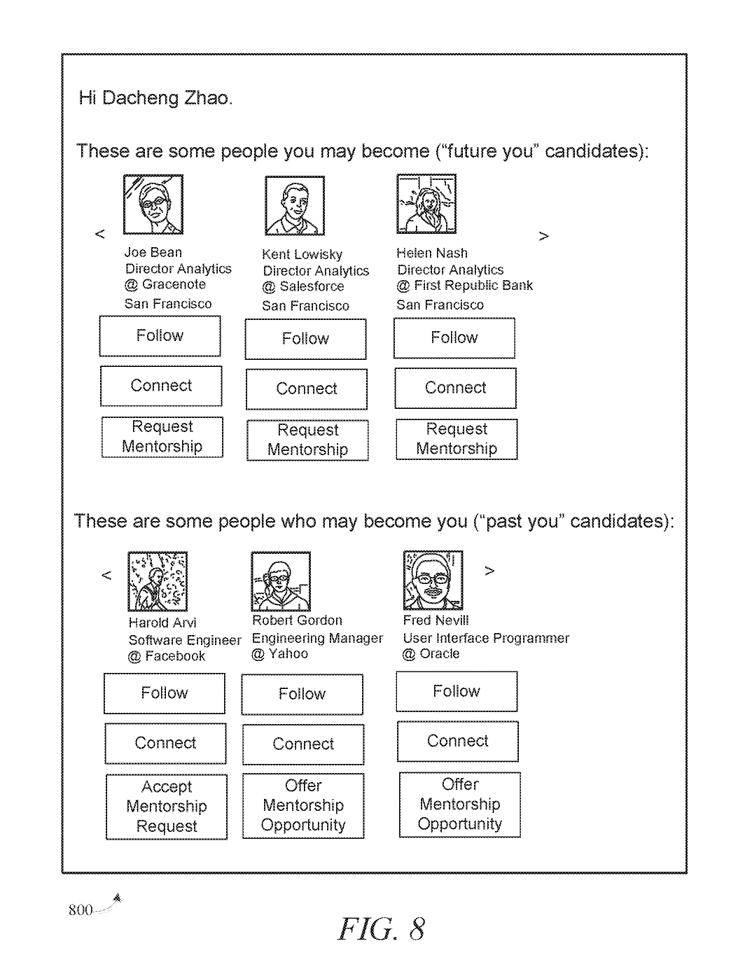

FIG. 8 is an example user interface 800 that may be presented in a client application executing on a device of a user to provide the user with options to participate in mentorship relationships with other members of the social networking system.

In various embodiments, sets of people you may become (e.g., “future you” candidates) are presented. Additionally, sets of people who may be come you (e.g., “past you” candidates) are presented. A member may use the lists to establish various types of relationships with other members of the social networking system. For example, a member may request to establish a mentorship relationship with a “future you” candidate, accept a mentorship request from a “past you” candidate, or offer a mentorship opportunity to a “past you” candidate.

Thus, in various embodiments, the user interface facilitates the establishment of mutually-agreed-upon mentorship relationships between members of the social networking system (e.g., as described above with respect to FIG. 4).

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces e.g., Application Program Interfaces (APIs)).

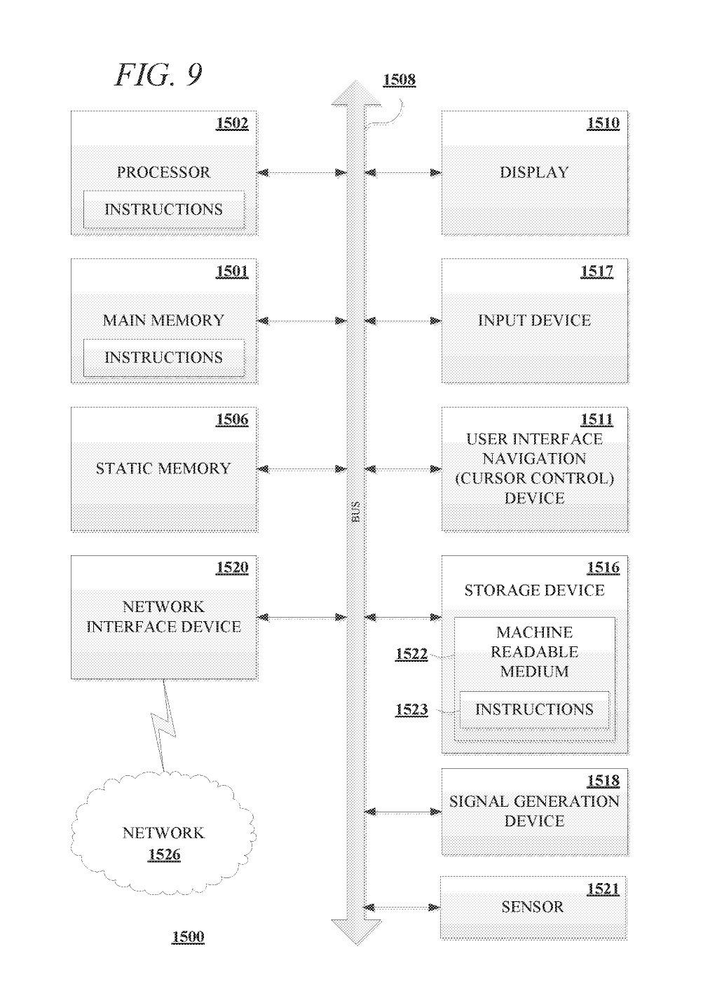

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
identifying a career path corresponding to a plurality of members of a social network system, identifying levels of professional qualifications of each of the plurality of members, the identifying including analyzing known data items pertaining to the levels of the professional qualifications and analyzing additional data items interred from the known data items pertaining to the levels of professional qualifications for each of the plurality of members;
identifying a career path gap between a member of the plurality of members and an additional member of the plurality of members, the career path gap including a difference in the levels of professional qualifications between the member and the additional member, the difference based on a comparison of the known data items and the additional data items corresponding to the member and the additional member; and
communicating information pertaining to the career path gap for presentation to the member in a user interface.

2. The method of claim 1, wherein the additional data is inferred based an application of a hidden Markov model to the known data items, the application of the hidden Markov model identifying multiple possible values for the additional data items and providing a probability for each of the multiple possible values.

3. The method of claim 2, wherein the multiple possible values relate to a miles corresponding to the career path.

4. The method of claim 3, wherein the milestone includes having a particular job title.

5. The method of claim 1, wherein the career path gap pertains to at least one of an educational qualification, a skill, a level of work experience, or an achievement of the member.

6. The method of claim 1, further comprising identifying the career path gap based on a comparison algorithm, the comparison algorithm comparing at least a subset of the data items corresponding to profile data associated with the member and the additional member.

7. The method of claim 6, wherein the identifying of the career path gap is further based on behavior data and social network data associated with the member and the additional member.

8. A system comprising:
one or more modules implemented by one or more processors, the one or more modules configured to, at least:
identify a career path corresponding to a plurality of members of a social network system;
identify levels of professional qualifications of each of the plurality of members, the identifying including analyzing known data items pertaining to the levels of the professional qualifications and analyzing additional data items inferred from the known data items pertaining to the levels of professional qualifications for each of the plurality of members:
identify a career path gap between a member of the plurality of members and an additional member of the plurality of members, the career path gap including a difference in the levels of professional qualifications between the member and the additional member, the difference based on a comparison of the known data items and the additional data items corresponding to the member and the additional member; and
communicate information pertaining to the career path gap for presentation to the member in a user interface.

9. The system of claim 8, wherein the additional data is interred based an application of a hidden Markov model to the known data items, the application of the hidden Markov model identifying multiple possible values for the additional data items and providing a probability for each of the multiple possible values.

10. The system of claim 9, wherein the multiple possible values relate to a milestone corresponding to the career path.

11. The system of claim 10, wherein the milestone includes having a particular job title.

12. The system of claim 8, wherein the career path gap pertains to at least one of an educational qualification, a skill, a level of work experience, or an achievement of the member.

13. The system of claim 8, further comprising identifying the career path gap based on a comparison algorithm, the comparison algorithm comparing at least a subset of the data items corresponding to profile data associated with the member and the additional member.

14. The system of claim 13, wherein the identifying of the career path gap is further based on behavior data and social network data associated with the member and the additional member.

15. A non-transitory computer-readable storage medium storing instructions thereon, which, when executed by one or more processors, cause the one or more processors to perform operations, the operations comprising:
identifying a career path corresponding to a plurality of members of a social network system;
identifying levels of professional qualifications of each of the plurality of members, the identifying including analyzing known data items pertaining to the levels of the professional qualifications and analyzing additional data items inferred from the known data items pertaining to the levels of professional qualifications for each of the plurality of members;
identifying a career path gap between a member of the plurality of members and an additional member of the plurality of members, the career path gap including a difference in the levels of professional qualifications between the member and the additional member, the difference based on a comparison of the known data items and the additional data items corresponding to the member and the additional member; and
communicating information pertaining to the career path gap for presentation to the member in a user interface.

16. The non-transitory computer-readable storage medium of claim 15, wherein the additional data is inferred based an application of a hidden Markov model to the known data items, the application of the hidden Markov model identifying multiple possible values for the additional data items and providing a probability for each of the multiple possible values.

17. The non-transitory computer-readable storage medium of claim 16, wherein the multiple possible values relate to a milestone corresponding to the career path.

18. The non-transitory computer-readable storage medium of claim 17, wherein the milestone includes having a particular job title.

19. The non-transitory computer-readable storage medium of claim 15, wherein the career path gap pertains to at least one of an educational qualification, a skill, a level of work experience, or an achievement of the member.

20. The non-transitory computer-readable storage medium of claim 15, further comprising identifying the career path gap based on a comparison algorithm, the comparison algorithm comparing at least a subset of the data items corresponding to profile data associated with the member and the additional member.
